(19) United States
(12) Patent Application Publication
(10) Pub. No.: US 2021/0035018 A1
(43) Pub. Date: Feb. 4, 2021

(54) Apparatus for verifying integrity of AI learning data and method therefor

(71) Applicant: Jeju National University Industry-Academic Cooperation Foundation, Jeju-si (KR)

(72) Inventors: In Kyung KIM, Jeju-si (KR); Namje Park, Jeju-si (KR); Donghyeok Lee, Jeju-si (KR)

(21) Appl. No.: 16/690,266

(22) Filed: Nov. 21, 2019

(30) Foreign Application Priority Data
Jul. 31, 2019 (KR) 10-2019-0093363

(51) Int. Cl. G06N 20/00

(52) U.S. Cl. CPC G06N 20/00

(57) ABSTRACT

Disclosed herein is an apparatus for verifying integrity of an AI learning data and a method therefor. According to the present invention, an original data received from at least one data provider and a hash code of the original data are stored on a blockchain. The original data stored on the blockchain is provided to an AI learning model. The hash code of data used on the AI learning model is compared with the hash code of the original data stored on the blockchain to verify the integrity of data.

### TECHNICAL FIELD

The present invention relates to a method for verifying integrity of data and an apparatus thereof and, more particularly, to a method for verifying integrity of data used on an AI learning and an apparatus thereof

### BACKGROUND ART

In the field of various kinds of AI (hereinafter referred to as “AI”) technologies including deep learning, the quality of AI models depends on that of learning data. When AI learning data becomes falsified by malicious attacks, there is a possibility that AI algorithm is malfunctioned.

In general, since AI model models are used by processing collected original data to be suitable for learning, rather than used as it is, there is a need for a way to guarantee data integrity preparing for attacks to original data or processing data.

### SUMMARY OF THE INVENTION

It is therefore an object of the present invention to provide a method for verifying integrity of data used on AI learning (training) and an apparatus thereof.

Embodiments of the present invention provide a method for verifying integrity of an AI learning data (i.e. training data) comprising, storing an original data received from at least one data provider and a hash code of the original data on a blockchain, providing the original data stored on the blockchain to an AI learning model, and comparing the hash code of data used on the AI learning model with the hash code of the original data stored on the blockchain to verify the integrity of data.

Embodiments of the present invention provide an apparatus for verifying integrity of an AI learning data comprising, a storage unit for storing an original data received from at least one data provider and a hash code of the original data on a blockchain, a providing unit for providing the original data stored on the blockchain to an AI learning model, and a verifying unit for comparing the hash code of data used on the AI learning model with the hash code of the original data stored on the blockchain to verify the integrity of data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein

FIG. 1 shows an example of a method for verifying integrity of an AI learning data according to an embodiment of the present invention;

FIG. 2 shows an example of a blockchain for storing original data according to an embodiment of the present invention;

FIG. 3 shows a schematic structure of a complete system in which an apparatus for verifying integrity of an AI learning data according to an embodiment of the present invention;

FIG. 4 shows an example of a verifying apparatus according to an embodiment of the present invention; and

FIG. 5 is a flowchart illustrating an example of a method for verifying integrity of a data according to an embodiment of the present invention.

### DETAILED DESCRIPTION

Hereinafter, the present invention will be described in detail with reference to the drawings. In describing the present invention, detailed descriptions related to publicly known functions or configurations will be omitted in order not to obscure the gist of the present invention.

The present invention may, however, be embodied in different forms and should not be construed as limited to the embodiments set forth herein.

Various modifications to the preferred embodiments will be readily apparent to those skilled in the art and the generic principles herein may be applied to other embodiments. Thus, the present invention is not limited to the embodiment shown but is to be accorded the widest scope consistent with the principles and features described herein.

The present invention may, however, be embodied in different forms and should not be construed as limited to the embodiments set forth herein. The same reference numeral is used to refer to like elements throughout.

In the specification, terms such as “include” or “have” should be understood as designating that features, number, steps, operations, elements, parts, or combinations thereof exist and not as precluding the existence of or the possibility of adding one or more other features, numbers, steps, operations, elements, parts, or combinations thereof in advance.

Hereinafter, the technical construction of the present invention will be described in detail with reference to preferred embodiments illustrated in the attached drawings.

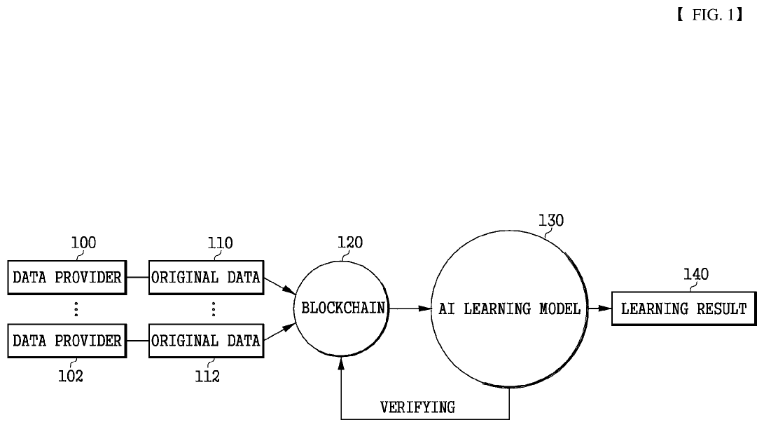

FIG. 1 shows an example of a method for verifying integrity of an AI learning data according to an embodiment of the present invention.

Referring to FIG. 1, original data 110 and 112 for AI learning may be received from at least one data providers 100 and 102. For instance, the original data 110 and 112 may be received from a plurality of the data providers 100 and 102 in an open-network circumstance.

In case that the original data 110 and 112 are provided from unspecified data providers 100 and 102, a malicious third party may falsify the original data 110 and 112 by system attacks or is impersonated as right data providers 100 and 102 to provide falsified data.

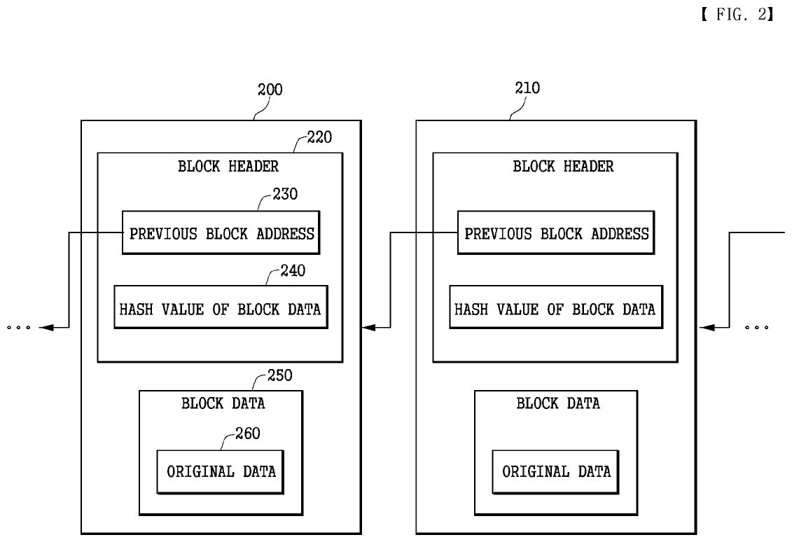

According to an embodiment of the present invention, in order to fundamentally prevent forgery of the original data 110 and 112 as well as exactly track the data providers 100 and 102 for providing the original data 110 and 112, the original data 110 and 112 are stored on a blockchain 120. For example, information such as user ID, terminal IP address, and so on for distinguishing the data providers 100 and 102 may be stored on the blockchain 120 together with the original data 110 and 112 in order to track the data providers 100 and 102. An example of the blockchain 120 for storing the original data 110 and 112 is shown in FIG. 2.

An AI learning model 130 performs a learning step using the original data 110 and 112 stored on the blockchain 120. The AI learning model 130 performs the using the original data 110 and 112 as it is or a pre-processing data created by transforming the original data 110 and 112 to be suitable in the learning step. While the original data 110 and 112 of their own as stored on the blockchain 120 can be prevented, the original data or the pre-processing data used in the learning step (i.e. training step) may be falsified by malicious attacks of a third party when the AI learning model 130 performs the learning flow.

In an embodiment according to the present invention, a method for verifying whether data (the original data or the pre-processing data) used in the learning step by the AI model 130 is falsified or not using the blockchain 120 is provided. For example, in case that the learning result of the AI learning model 130 is abnormal, it is possible to check normality or falsification by comparing the data used in the learning step with the original data as stored on the blockchain 120.

FIG. 2 shows an example of a blockchain for storing original data according to an embodiment of the present invention.

Referring to FIG. 2, the blockchain 120 includes a plurality of blocks 200 and 210, which are sequentially connected. Each of the blocks 200 and 210 comprises a block header 220 and a block data 250. The block header 220 includes a previous block address 230 and a hash value 240 of the block data 250. The previous block address 230 is configured with a hash value of a block header of a previous block. The block data 250 includes an original data 260 received from a data provider.

The original data 250 is stored on the block data 250 as it is or as encrypted to be stored on the block data 250. In an embodiment of the present invention, the block data 250 further includes a hash code of the original data 260. In another embodiment of the present invention, a first blockchain storing the original data 260 and a second blockchain storing a hash code of the original data 260 may exist, respectively.

It will be understood that the blockchain according to an embodiment of the present invention are illustrative and that the scope of the invention is not limited to them. Many variations, modifications, additions and improvements of the data included in the block header 220 and the block data 250 of the blockchain are possible.

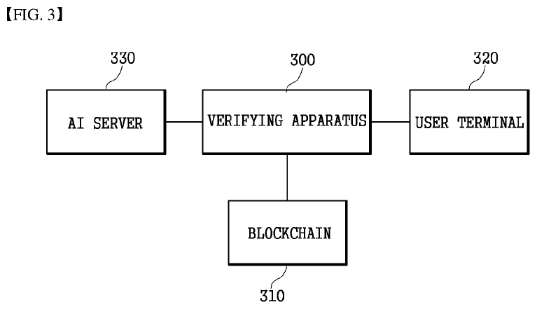

FIG. 3 shows a schematic structure of a complete system in which an apparatus for verifying integrity of an AI learning data according to an embodiment of the present invention.

Referring to FIG. 3, a verifying apparatus 300 is connected with a user terminal 320 and an AI server 330. The user terminal 320 is used by a data provider and may be various kinds of terminals such as a computer, a smart phone, and so forth. The AI server 330 is a server making various kinds of conventional AI learning models such as a deep learning study.

The verifying apparatus 300 is connected through various kinds of wire/wireless communication networks to the user terminal 320. In an embodiment of the present invention, one user terminal 320 is shown in FIG. 3 for convenience of explanation. However, as shown in FIG. 1, in case that the original data is received from the plurality of the data providers, the verifying apparatus 300 can be connected to the user terminal of each of the data providers.

The verifying apparatus 300 is connected to the blockchain 310. As an example, the verifying apparatus 300 is connected to one of the plurality of the servers constituting the blockchain 310, or the verifying apparatus 300 is one constituting one of the servers constituting the blockchain 310.

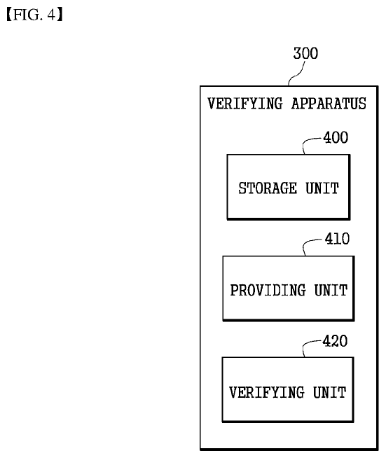

If the original data is received from the user terminal 320, the verifying apparatus 300 stores the original data on the blockchain 310. If the original data is requested from the AI server 330, the original data stored on the blockchain 310 is provided to the AI server 330 by the verifying apparatus 300. In addition, if the integrity verification of the original data is requested from the AI server 330, the verifying apparatus 300 verifies the integrity of the original data. The detailed structure of the verifying apparatus 300 will be described in FIG. 4.

FIG. 4 shows an example of a verifying apparatus according to an embodiment of the present invention.

Referring to FIG. 4, the verifying apparatus 300 includes a storage unit 400, a providing unit 410, and a verifying unit 420.

The storage unit 400 stores an original data received from a data provider on a blockchain. The storage unit 400 can encrypt the original data to be capable of storing it. The encryption of the original data is performed in a user terminal of the data provider or the verifying apparatus 300. For example, if the storage unit 400 includes an encryption key and a decryption key, and receives original data from the data provider, it encrypts the original data to be capable of storing it on the blockchain.

In another embodiment of the present invention, the storage unit 400 receives the original data encrypted in the user terminal to be capable of storing it on a blockchain. In this case, the storage unit 400 shares the decryption key for decrypting the encrypted original data with the user terminal by various conventional methods. If there exist a plurality of data providers, the verifying apparatus 300 has to manage and store a plurality of the decryption keys, which correspond to the encryption keys of the plurality of the data providers.

In another embodiment of the present invention, the verifying apparatus 300 provides an encryption key to a user terminal by various conventional methods. For instance, after the verifying apparatus 300 creates an encryption key and a decryption key, the encryption key is provided to a plurality of data providers (that is, a plurality of user terminals) through various key agreement methods. Then, the plurality of data providers encode an original data using the received encryption key and then provide the encoded data back to the verifying apparatus 300. In this case, even though there exist the plurality of data providers, the original data is encoded using the same encryption key, so that the storage unit 400 only needs to store and manage one decryption key.

The storage unit 400 can store a hash code of the original data as well as the original data. The storage unit 400 stores the original data and the hash code on one blockchain together or stores them on each of blockchains, separately.

If the providing unit 410 is requested to provide the original data from an AI server, it provides the original data stored on the blockchain to the AI server 330. If the original data stored on the blockchain is encrypted, the providing unit 410 decrypts the encrypted original data to provide to the AI server 330.

If the integrity verification of data is requested from the AI server 330, the verifying unit 420 verifies the integrity using the hash code of the original data stored on the blockchain, and then provides the verification result to the AI server 330. For example, AI server 330 transmits the training data used in AI learning or a hash code of the training data to the verifying unit 420 and requests its integrity verification.

The verifying unit 420 compares the hash code of the data received from the AI server 330 with the hash code of the original data stored on the blockchain to check whether there exists a consistency value or not. If the consistency value does not exist, the verifying unit 420 decides that the requested data to be verified is falsified.

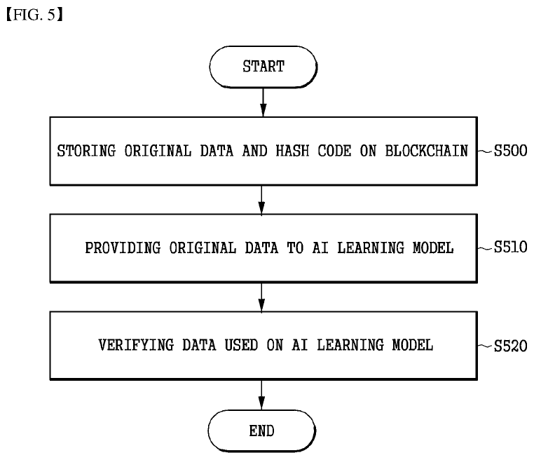

FIG. 5 is a flowchart illustrating an example of a method for verifying integrity of a data according to an embodiment of the present invention.

Referring to FIG. 5, the verifying apparatus 300 stores an original data received from at least one data provider and a hash code of the original data on a blockchain (S500). The verifying apparatus 300 can encrypt the original data to be capable of storing it.

The verifying apparatus 300 provides the original data stored on the blockchain to the AI server 330 (S510). If the integrity verification of data or a hash code of the data from the AI server is requested, the verifying apparatus 300 compares the hash code of the data received from the AI server with the hash code of the original data stored on the blockchain to verify whether there exists a falsification or not (S520).

It is possible that the present invention is embodied as a computer-readable code on a computer-readable recording medium. The computer-readable recording medium includes all kinds of recording devices in which computer-readable data is stored. Examples of computer-readable recording media are ROM, RAM, CD-ROM, Magnetic Tape, Floppy Disk, Optical Data Device, and so forth. In addition, computer-readable recording media are distributed to a computer system connected by networks, a computer-readable code is stored and performed in a distributed method.

According to an embodiment of the present invention, an original data that will be used on an AI learning can be safely kept using a blockchain from malicious attacks of a third party. In addition, the integrity of the data used by an AI model can be verified through a blockchain. For example, when the result value of the AI model is abnormally output, whether a corresponding learning data is falsified can be verified through a blockchain.

Furthermore, various original data are collected from a plurality of data providers through an open network to be used as a learning data. And, an original data is encrypted and stored to be capable of protecting privacy of personal information.

All such changes, modifications, variations and other uses and applications which do not depart from the spirit and scope of the invention are deemed to be covered by the invention which is limited only by the claims which follow.

1. A method for verifying integrity of an AI learning data comprising:
storing an original data received from at least one data provider and a hash code of the original data on a blockchain;
providing the original data stored on the blockchain to an AI learning model; and
comparing the hash code of data used on the AI learning model with the hash code of the original data stored on the blockchain to verify the integrity of data.

2. The method of claim 1, wherein storing original data includes encrypting the original data to be stored on the blockchain.

3. An apparatus for verifying integrity of an AI learning data comprising:
a storage unit for storing an original data received from at least one data provider and a hash code of the original data on a blockchain;
a providing unit for providing the original data stored on the blockchain to an AI learning model; and
a verifying unit for comparing the hash code of data used on the AI learning model with the hash code of the original data stored on the blockchain to verify the integrity of data.

4. The apparatus of claim 3, wherein the storage unit encrypts the original data to be stored on the blockchain.

5. A computer-readable recording medium having stored thereon a program for performing the method of claim 1.
